(19) United States
(12) Patent Application Publication
(10) Pub. No.: US 2024/0211322 A1
(43) Pub. Date: Jun. 27, 2024

(54) COMPUTER-READABLE RECORDING MEDIUM STORING DATA CONTROL PROGRAM, DATA CONTROL METHOD, AND INFORMATION PROCESSING APPARATUS

(71) Applicant: Fujitsu Limited, Kawasaki-shi (JP)

(72) Inventor: Jun KATO, Kawasaki (JP)

(73) Assignee: Fujitsu Limited, Kawasaki-shi (JP)

(21) Appl. No.: 18/463,330

(22) Filed: Sep. 8, 2023

(30) Foreign Application Priority Data
Dec. 21, 2022 (JP) 2022-204030

(51) Int. Cl. G06F 9/54; G06F 9/50

(52) U.S. Cl. CPC G06F 9/54; G06F 9/505; G06F 2209/5022; G06F 2209/509

(57) ABSTRACT

A non-transitory computer-readable recording medium stores a program for causing a computer to execute a data control process in an information processing apparatus including: a first processor; and a second processor that has a processing speed slower than the processing speed of the first processor.

The process includes, upon reception of a request for asynchronous data processing, causing the first processor to execute processing that determines whether or not to offload processing of the request to the second processor based on a state of the first processor.

### CROSS-REFERENCE TO RELATED APPLICATION

This application is based upon and claims the benefit of priority of the prior Japanese Patent Application No. 2022-204030, filed on Dec. 21, 2022, the entire contents of which are incorporated herein by reference.

### FIELD

The embodiments discussed herein are related to a data control program, a data control method, and an information processing apparatus.

### BACKGROUND

High performance computing (HPC) is known as a technique capable of executing high-speed data processing and complex calculation. Since an HPC environment is based on the premise that a user is capable of using a supercomputer, a hurdle for the user to get started is high, and it is also difficult for a manufacturer side to obtain new users.

Japanese National Publication of International Patent Application No. 2016-503933, Japanese Laid-open Patent Publication No. 2017-174301, U.S. U.S. Pat. No. 9,684,597, and U.S. Patent Application Publication No. 2017/0346700 are disclosed as related art.

### SUMMARY

According to an aspect of the embodiments, a non-transitory computer-readable recording medium stores a program for causing a computer to execute a data control process in an information processing apparatus including: a first processor; and a second processor that has a processing speed slower than the processing speed of the first processor. The process includes, upon reception of a request for asynchronous data processing, causing the first processor to execute processing that determines whether or not to offload processing of the request to the second processor based on a state of the first processor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of an information processing apparatus as an example of an embodiment;

FIG. 2 is a hardware configuration diagram of the information processing apparatus as an example of the embodiment;

FIG. 3 is a diagram schematically illustrating a hardware configuration of a network interface of the information processing apparatus as an example of the embodiment;

FIG. 4 is a diagram illustrating an outline of a process in the information processing apparatus as an example of the embodiment;

FIG. 5 is a diagram exemplifying control data in the information processing apparatus as an example of the embodiment;

FIG. 6 is a diagram for explaining a data path in the information processing apparatus as an example of the embodiment;

FIG. 7 is a diagram for explaining a data path in the information processing apparatus as an example of the embodiment;

FIG. 8 is a diagram for explaining a data path in the information processing apparatus as an example of the embodiment;

FIG. 9 is a flowchart for explaining a process at a time of request issuance on a host side in the information processing apparatus as an example of the embodiment;

FIG. 10 is a flowchart for explaining a process of a request detection unit in the information processing apparatus as an example of the embodiment;

FIG. 11 is a flowchart for explaining details of step B3 in the flowchart illustrated in FIG. 10;

FIG. 12 is a flowchart for explaining a process of a processing determination unit of a host in the information processing apparatus as an example of the embodiment;

FIG. 13 is a diagram illustrating asynchronous processing of I/O data by the present information processing apparatus in comparison with an existing method;

FIG. 14 is a diagram illustrating the asynchronous processing of the I/O data by the present information processing apparatus in comparison with the existing method; and

FIG. 15 is a diagram illustrating synchronization timing among a plurality of MPI processes in an HPC application.

### DESCRIPTION OF EMBODIMENTS

In view of the above, in recent years, it has been achieved to operate an HPC application in a cloud service, which has greatly reduced the barrier to entry into the HPC. Since a central processing unit (CPU), a memory capacity, and the like may be adjusted according to a workload in the case of using the cloud, it becomes easier to achieve a target at a low cost and to optimize cost performance.

The HPC application commonly performs parallel processing using the Message Passing Interface (MPI).

For example, many applications in Kubernetes, which is known as a cloud virtual infrastructure, employ the microservice architecture, and combine a plurality of independent small microservices to perform processing basically sequentially.

While multiple MPI processes perform processing in parallel in the HPC application, they do not run in parallel on a continuous basis, and synchronization needs to be carried out among the multiple MPI processes at some timing.

When there is a difference in timing at which the MPI processes synchronize in the HPC application, rate limiting to the latest process is carried out. Therefore, even if the processing of the multiple MPI processes is written in exactly the same manner at the application level, a deviation occurs due to operating system (OS) noise. The OS noise is a generic term for application execution delays caused by processing other than an application, such as an OS daemon, a kernel daemon, interrupt processing, and the like.

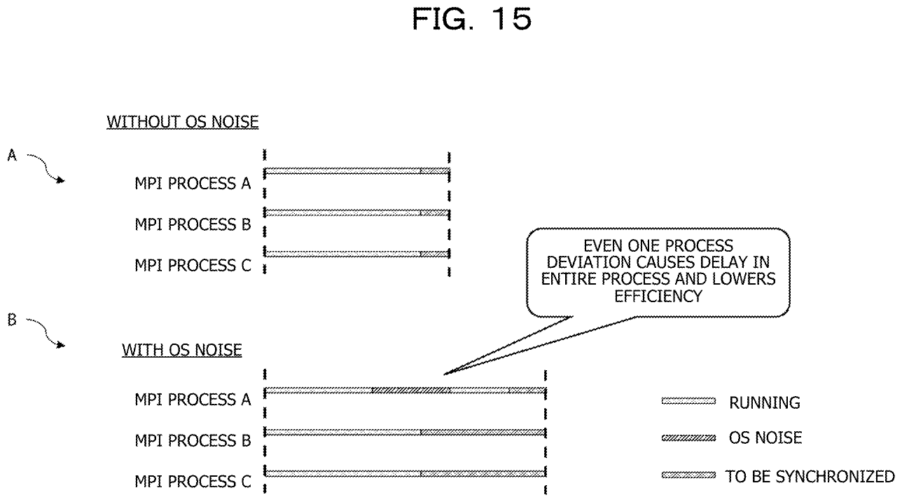

FIG. 15 is a diagram illustrating synchronization timing among a plurality of MPI processes in the HPC application, in which a reference sign A indicates an example without OS noise and a reference sign B indicates an example with OS noise.

In the example indicated by the reference sign B in FIG. 15, OS noise is generated in an MPI process A, which causes the synchronization waiting time of an MPI process B and an MPI process C to be longer, whereby the entire process delays. Even when OS noise is generated only in one MPI process and a delay (deviation) occurs in the process, the entire process is affected and delayed. As a result, completion of the entire process delays as compared with the case without OS noise, which lowers efficiency.

In one aspect, an object of the embodiments is to reduce OS noise.

Hereinafter, embodiments of the present data control program, data control method, and information processing apparatus will be described with reference to the drawings. Note that the embodiments to be described below are merely examples, and there is no intention to exclude application of various modifications and techniques not explicitly described in the embodiments. For example, the present embodiments may be variously modified and implemented in a range without departing from the spirit thereof.

Furthermore, each drawing is not intended to include only components illustrated in the drawing, and may include another function and the like.

### (A) Configuration

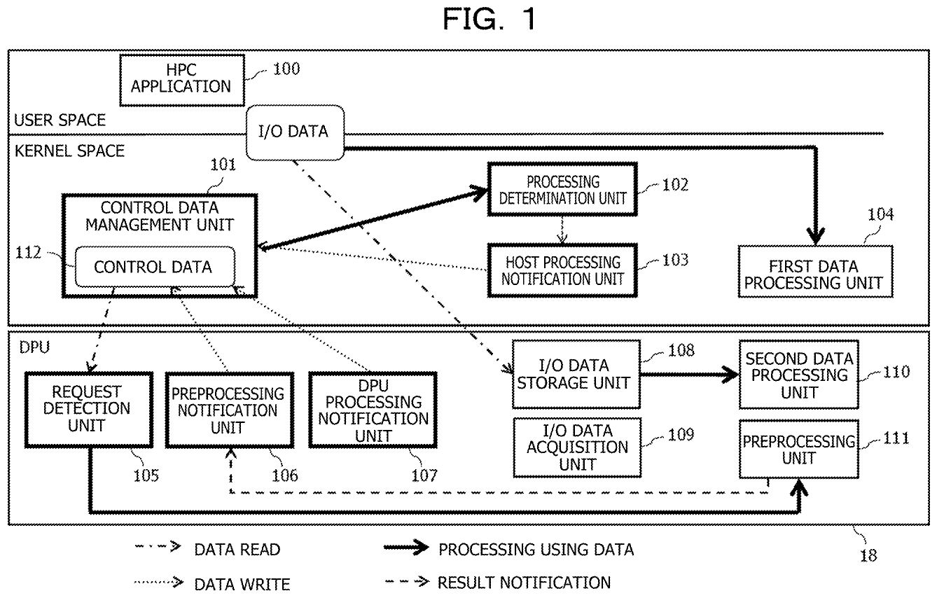

FIG. 1 is a diagram schematically illustrating a configuration of an information processing apparatus 1 as an example of the embodiment.

This information processing apparatus 1 implements a cloud computing environment, and runs an HPC application 100 in a container implemented by container-based virtualization technology, for example. A cloud virtual infrastructure in the information processing apparatus 1 may be, for example, Kubernetes.

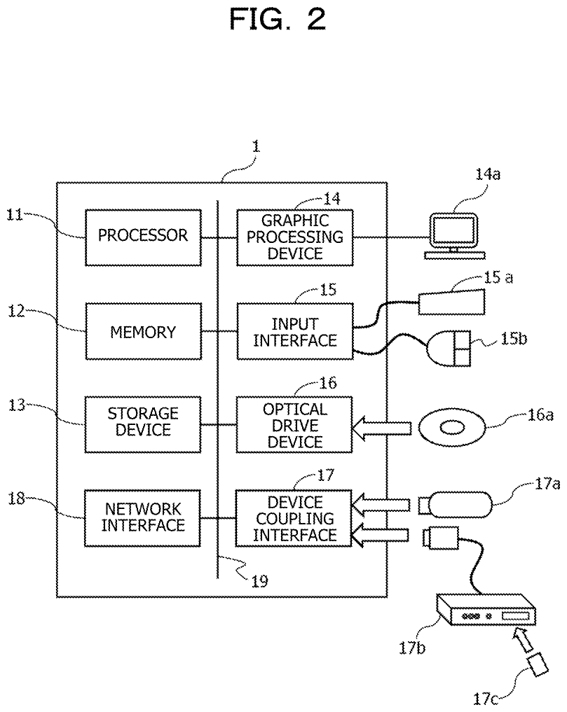

FIG. 2 is a hardware configuration diagram of the information processing apparatus 1 as an example of the embodiment.

The information processing apparatus 1 includes, for example, a processor 11, a memory 12, a storage device 13, a graphic processing device 14, an input interface 15, an optical drive device 16, a device coupling interface 17, and a network interface 18 as components. Those components 11 to 18 are configured to be mutually communicable via a bus 19.

The processor (processing unit) 11 controls the entire information processing apparatus 1. The processor 11 may be a multiprocessor, or may be a multi-core processor. The processor 11 may also be, for example, any one of a central processing unit (CPU), a micro processing unit (MPU), a digital signal processor (DSP), an application specific integrated circuit (ASIC), a programmable logic device (PLD), and a field programmable gate array (FPGA). Furthermore, the processor 11 may also be a combination of two or more types of elements of the CPU, MPU, DSP, ASIC, PLD, and FPGA.

Then, the processor 11 executes a program (data control program, OS program) recorded in a computer-readable non-transitory recording medium, for example, thereby implementing functions as a control data management unit 101, a processing determination unit 102, a host processing notification unit 103, and a first data processing unit 104 exemplified in FIG. 1.

Furthermore, the processor 11 runs the HPC application 100, whereby the information processing apparatus 1 implements a function as HPC. The processor 11 may be referred to as a host processor or simply as a host. Note that the processor 11 is an example of a first processor.

The program in which processing content to be executed by the information processing apparatus 1 is described may be recorded in various recording media. For example, the program to be executed by the information processing apparatus 1 may be stored in the storage device 13. The processor 11 loads at least a part of the program in the storage device 13 into the memory 12, and executes the loaded program.

Furthermore, the program to be executed by the information processing apparatus 1 (processor 11) may be recorded in a non-transitory portable recording medium such as an optical disc 16a, a memory device 17a, or a memory card 17c. The program stored in the portable recording medium may be executed after being installed in the storage device 13 under the control of the processor 11, for example. Furthermore, the processor 11 may directly read the program from the portable recording medium and execute the program.

The memory 12 is a storage memory including a read only memory (ROM) and a random access memory (RAM). The RAM of the memory 12 is used as a main storage device of the information processing apparatus 1. The RAM temporarily stores at least a part of the program to be executed by the processor 11. Furthermore, the memory 12 stores various types of data needed for processing by the processor 11.

The storage device 13 is a storage device such as a hard disk drive (HDD), a solid state drive (SSD), a storage class memory (SCM), or the like, and stores various types of data. The storage device 13 may store control data 112 and I/O data created by the HPC application 100.

Note that a semiconductor storage device such as an SCM, a flash memory, or the like may be used as an auxiliary storage device. Furthermore, redundant arrays of inexpensive disks (RAID) may be configured using a plurality of the storage devices 13.

The graphic processing device 14 is coupled to a monitor 14a. The graphic processing device 14 displays an image on a screen of the monitor 14a in accordance with a command from the processor 11. Examples of the monitor 14a include a display device using a cathode ray tube (CRT), a liquid crystal display device, and the like.

The input interface 15 is coupled to a keyboard 15a and a mouse 15b. The input interface 15 transmits signals sent from the keyboard 15a and the mouse 15b to the processor 11. Note that the mouse 15b is an exemplary pointing device, and another pointing device may also be used. Examples of the another pointing device include a touch panel, a tablet, a touch pad, a track ball, and the like.

The optical drive device 16 reads data recorded in the optical disc 16a using laser light or the like. The optical disc 16a is a non-transitory portable recording medium in which data is recorded in a readable manner by reflection of light. Examples of the optical disc 16a include a digital versatile disc (DVD), a DVD-RAM, a compact disc read only memory (CD-ROM), a CD-recordable (R)/rewritable (RW), and the like.

The device coupling interface 17 is a communication interface for coupling a peripheral device to the information processing apparatus 1. For example, the device coupling interface 17 may be coupled to the memory device 17a and a memory reader/writer 17b. The memory device 17a is a non-transitory recording medium equipped with a function of communicating with the device coupling interface 17, for example, a universal serial bus (USB) memory. The memory reader/writer 17b writes data to the memory card 17c or reads data from the memory card 17c. The memory card 17c is a card-type non-transitory recording medium.

The network interface 18 is coupled to a network. The network interface 18 transmits and receives data via the network. The network interface 18 may be referred to as a network interface card (NIC).

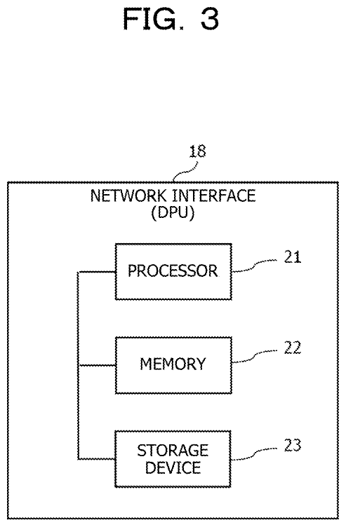

FIG. 3 is a diagram schematically illustrating a hardware configuration of the network interface 18 of the information processing apparatus 1 as an example of the embodiment.

The network interface 18 exemplified in FIG. 3 is a data processing unit (DPU) including a processor 21, a memory 22, and a storage device 23. The network interface 18 may be referred to as a DPU 18. Furthermore, the network interface 18 also includes an interface (not illustrated) for coupling to a network, and the like.

The processor (processing unit) 21 controls the entire network interface 18. The processor 21 may be, for example, an Advanced RISC Machines (ARM) processor. The processor 21 has a processing speed slower than that of the processor 11 described above. Note that the processor 21 is an exemplary second processor.

Note that the processor 21 is not limited to this. For example, the processor 21 may be a multiprocessor or a multi-core processor. Furthermore, the processor 21 may also be, for example, any one of the CPU, MPU, DSP, ASIC, PLD, and FPGA. Furthermore, the processor 21 may also be a combination of two or more types of elements of the CPU, MPU, DSP, ASIC, PLD, and FPGA.

Then, the processor 21 executes a program (DPU data control program) recorded in a computer-readable non-transitory recording medium, for example, thereby implementing functions as a request detection unit 105, a preprocessing notification unit 106, a DPU processing notification unit 107, an I/O data acquisition unit 109, a second data processing unit 110, and a preprocessing unit 111 exemplified in FIG. 1.

The program in which processing content to be executed by the processor 21 is described may be recorded in various recording media. For example, the program to be executed by the processor 21 may be stored in the storage device 23. The processor 21 loads at least a part of the program in the storage device 23 into the memory 22, and executes the loaded program.

Furthermore, the program to be executed by the processor 21 may be recorded in a non-transitory portable recording medium such as the optical disc 16a, the memory device 17a, or the memory card 17c described above. The program stored in the portable recording medium may be executed after being installed in the storage device 23 under the control of the processor 11 or the processor 21, for example. Furthermore, the processor 21 may directly read the program from the portable recording medium and execute the program.

The memory 22 is a storage memory including a ROM and a RAM. The RAM of the memory 22 is used as a main storage device of the DPU 18. The RAM temporarily stores at least a part of the program to be executed by the processor 21. Furthermore, the memory 22 stores various types of data needed for processing by the processor 21. Furthermore, the memory 22 may function as an I/O data storage unit 108 (see FIG. 1) that stores I/O data.

The storage device 23 is a storage device such as an HDD, an SSD, or an SCM, and stores various types of data. The storage device 23 may store a DPU data control program. Furthermore, the storage device 23 may function as the I/O data storage unit 108 that stores I/O data.

The network interface 18 may be coupled to another information processing apparatus, a communication device, and the like via a network (not illustrated). For example, an information processing apparatus of a user who uses the cloud computing environment provided by the HPC application 100 may be coupled.

In the present information processing apparatus 1, processing of I/O data is asynchronously performed independently of the processing of the HPC application 100. Then, the host (processor 11) and the DPU (network interface) 18 perform hybrid asynchronous processing.

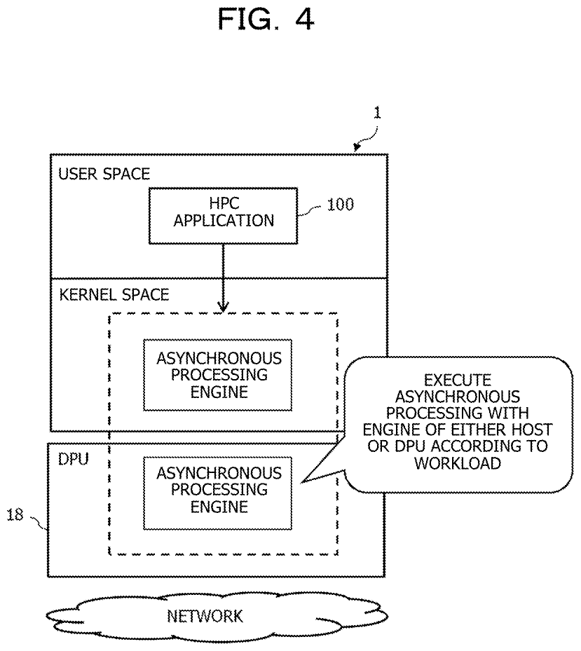

FIG. 4 is a diagram illustrating an outline of a process in the information processing apparatus 1 as an example of the embodiment.

In the present information processing apparatus 1, the processing of the I/O data caused by the HPC application 100 is divided into processing by the host (processor 11) and processing by the DPU 18 depending on the workload of the host.

For example, the host and the DPU 18 cooperate to automatically determine which performs asynchronous I/O data processing, and offload the I/O data processing to the DPU 18 when the host is in a busy state or the like.

Each of the processor 11 and the processor 21 may be referred to as an engine. In the present information processing apparatus 1, asynchronous processing is performed on the I/O data by the engine of either the host or the DPU 18 according to the workload of the host. Both of the processor 11 and the processor 21 correspond to an asynchronous processing engine.

The present information processing apparatus 1 may be applied to, for example, storage control, or may be applied to data communication control.

The HPC application 100 runs in a user space of the host. The HPC application 100 issues a request related to the I/O data. The I/O data is stored in, for example, a predetermined storage area such as the storage device 13, the memory 12, or the like. Furthermore, the request related to the I/O data is notified to the control data management unit 101.

The processing determination unit 102 determines whether or not to process the request related to the I/O data in the host.

The processing determination unit 102 obtains a profile of the processor 11, and determines whether or not to process the request related to the I/O data in the host based on the obtained profile. The profile may be, for example, a CPU usage rate (CPU usage) or a CPU load factor.

When the value of the obtained profile is lower than a preset threshold, the processing determination unit 102 determines that the processor 11 (host) is capable of processing the request related to the I/O data. The threshold may be, for example, a value that ensures that no OS noise is generated, and may be set based on an experiment performed in advance or experience.

In a case where the information processing apparatus 1 includes a plurality of processors 11, the processing determination unit 102 obtains a profile for each of those processors 11, and determines whether or not the I/O data request processing is executable. When the profile value of at least one processor 11 of the plurality of processors 11 is lower than the threshold, the processing determination unit 102 may determine that the I/O data request processing is executable in the host. Furthermore, the processing determination unit 102 may compare the average value of the profile values of the plurality of processors 11 with the threshold, and various modifications may be made and implemented.

When a value (CPU usage rate, CPU load factor) representing a load state of the processor 11 is lower than a threshold, the processing determination unit 102 determines to cause the processor 11 to process the request related to the I/O data. On the other hand, when the value representing the load state of the processor 11 is equal to or higher than the threshold, the processing determination unit 102 suppresses execution of the I/O data request processing by the processor 11.

In a case of not processing the request related to the I/O data in the processor 11 (host), the DPU 18 to be described later processes the request related to the I/O data. Therefore, it may be said that the processing determination unit 102 determines whether or not to offload the I/O data request processing to the DPU 18.

When the processing determination unit 102 receives the request of the I/O data (asynchronous data) processing, it determines whether or not to offload the I/O data request processing to the DPU 18 based on a state (load state, workload) of the processor 11.

The processing determination unit 102 notifies the host processing notification unit 103 of a determination result.

The function as the processing determination unit 102 may be implemented by a runtime profiler.

In the host, the runtime profiler may be executed after the preprocessing notification unit 106 to be described later writes a preprocessing result to the control data 112.

When the processing determination unit 102 determines that the I/O data may be processed in the host, the host processing notification unit 103 instructs the control data management unit 101 to set a host processing mark in the control data 112 related to the I/O data, thereby making an attempt to set the host processing mark in the control data 112.

At this time, the host processing notification unit 103 refers to the control data 112 to check whether there is I/O data executable in the host, and attempts to set a host processing mark in the control data 112 when there is a request related to the executable I/O data.

The function as the host processing notification unit 103 may be implemented by a worker thread. The host processing notification unit 103 may directly write the host processing mark in the control data 112.

The control data management unit 101 manages the control data 112.

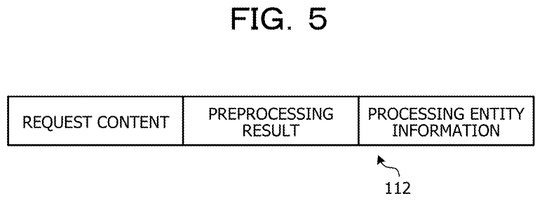

FIG. 5 is a diagram exemplifying the control data 112 in the information processing apparatus 1 as an example of the embodiment.

The control data 112 is information for managing I/O data processing, and may include, for example, contents of a request related to the I/O data, a preprocessing result, and processing entity information.

The contents of the request related to the I/O data may include, for example, position (address) information of the I/O data to be processed. Furthermore, in a case of using the present information processing apparatus 1 for storage control, the contents of the request may include information regarding a write destination of the I/O data and the like. Meanwhile, in a case of using the present information processing apparatus 1 for communication control, the contents of the request may include information regarding a destination (endpoint) of the I/O data and the like.

The preprocessing result is information indicating a result of processing performed by the preprocessing unit 111 to be described later. The processing entity information is information for managing an entity that executes an I/O data processing request. The processing entity information may be either a host processing mark indicating that the host processes the I/O data processing request or a DPU processing mark indicating that the DPU 18 processes the I/O data processing request.

Either the host processing mark or the DPU processing mark is exclusively set in the processing entity information. Therefore, when a host processing mark has already been set in the processing entity information of the control data 112, it is not possible to set a DPU processing mark in the control data 112. Likewise, when a DPU processing mark has already been set in the processing entity information of the control data 112, it is not possible to set a host processing mark in the control data 112.

The host processing mark is set by notification from the host processing notification unit 103, and the DPU processing mark is set by the DPU processing notification unit 107 to be described later.

The control data 112 includes the processing entity information to function as control information for managing the processing entity of the request.

The control data 112 may be generated for each I/O data processing request. Each time the HPC application 100 issues an I/O data processing request, the control data management unit 101 creates the control data 112 corresponding to the I/O data processing request. When the HPC application 100 issues a plurality of I/O data processing requests, the control data management unit 101 generates the control data 112 for each of those processing requests.

Furthermore, the control data management unit 101 may manage the control data 112 according to the order in which the HPC application 100 issues the I/O data processing request.

When notification indicating that the host executes the I/O data request processing is received from the host processing notification unit 103, the control data management unit 101 sets the host processing mark in the processing entity information for, among the pieces of control data 112 managed by itself, the control data 112 in which neither the host processing mark nor the DPU processing mark is set in the processing entity information.

Furthermore, the DPU processing mark is set in the processing entity information by the DPU processing notification unit 107 for, among the pieces of control data 112, the control data 112 in which neither the host processing mark nor the DPU processing mark is set in the processing entity information.

When the first data processing unit 104 or the second data processing unit 110 completes the I/O data request processing, the control data management unit 101 may abandon or delete the control data 112 corresponding to the I/O data.

When the processing determination unit 102 determines to perform the I/O data request processing in the host, the first data processing unit 104 executes the I/O data request processing. The first data processing unit 104 executes the I/O data request processing in which the host processing mark is set in the control data 112.

The function as the first data processing unit 104 may be implemented by a worker thread.

Each of the functions of the control data management unit 101, the processing determination unit 102, the host processing notification unit 103, and the first data processing unit 104 described above is implemented in a kernel space of the host.

The request detection unit 105 refers to the control data 112 to detect an I/O data processing request, and reads the contents of the request. The request detection unit 105 performs polling on the control data 112 by Remote Direct Memory Access (RDMA) Read operation, and obtains the contents of the request.

The request detection unit 105 notifies the preprocessing unit 111 of the contents of the request read from the control data 112. When the request detection unit 105 detects the request in the control data 112, it may start a worker thread.

The function as the request detection unit 105 may be implemented by a control thread.

The preprocessing unit 111 performs preprocessing for the I/O data processing request. The preprocessing is processing to be performed before the second data processing unit 110 processes the I/O data (actual data), which is, for example, processing related to metadata in storage control.

The function as the preprocessing unit 111 may be implemented by a worker thread.

The preprocessing notification unit 106 records a processing result of the preprocessing unit 111 in the control data 112 as a result of the preprocessing. The preprocessing notification unit 106 writes the result of the preprocessing in the control data 112 by the RDMA Write.

Each processing of the preprocessing unit 111 and the preprocessing notification unit 106 may not be executed in a case of data processing that needs no preprocessing (e.g., I/O data processing related to communication control).

The I/O data acquisition unit 109 obtains I/O data of the host. The I/O data acquisition unit 109 reads I/O data from the storage device 13 or the memory 12, and stores it in the I/O data storage unit 108.

The I/O data storage unit 108 stores the I/O data obtained by the I/O data acquisition unit 109.

For the I/O data obtained by the I/O data acquisition unit 109, the DPU processing notification unit 107 makes an attempt to write a DPU processing mark in the control data 112 corresponding to the I/O data by RDMA ATOMIC operation.

When a host processing mark has already been set in the control data 112, the DPU processing notification unit 107 does not write the DPU processing mark in the control data 112. In this case, execution of the I/O data request processing related to the control data 112 by the second data processing unit 110 is suppressed in the DPU 18, and the execution of the I/O data request processing is executed by the host side (first data processing unit 104).

The function as the DPU processing notification unit 107 may be implemented by a control thread.

The second data processing unit 110 processes the I/O data stored in the I/O data storage unit 108.

The second data processing unit 110 processes a request for the I/O data related to the control data 112 in which the DPU processing mark is set by the DPU processing notification unit 107. The second data processing unit 110 implements a function of processing the request received by the processor 11 in the DPU 18.

In a case where a host processing mark is set in the processing entity information of the control data 112, the second data processing unit 110 does not process the control data 112. As a result, the second data processing unit 110 implements a function of suppressing execution of the request processing. The function as the second data processing unit 110 may be implemented by a worker thread.

### (B) Operation

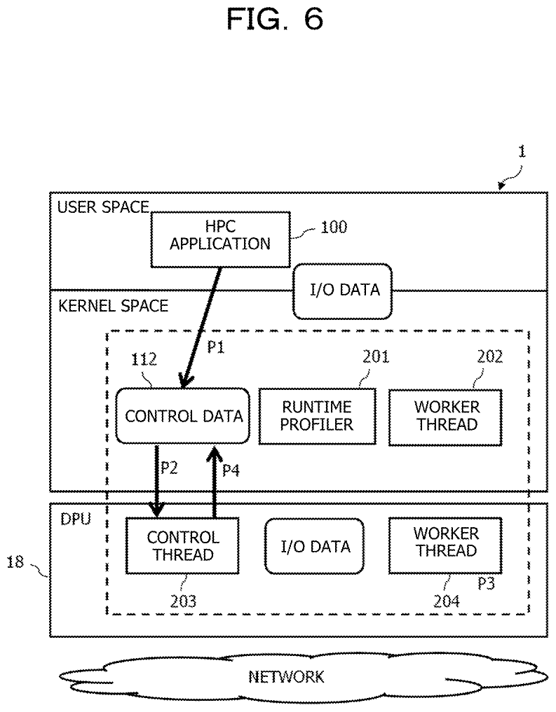

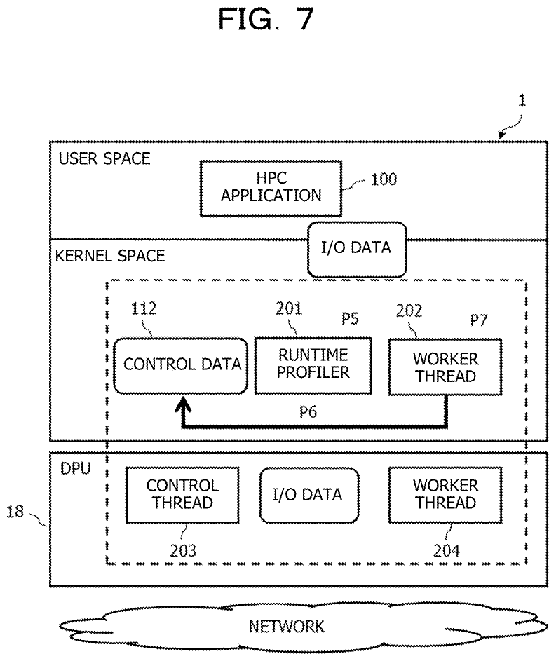

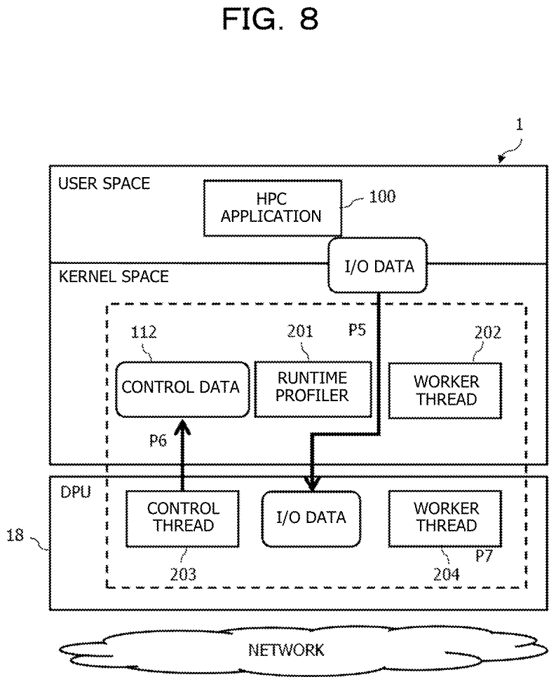

First, a data path in the information processing apparatus 1 as an example of the embodiment configured as described above will be described with reference to FIGS. 6 to 8. Note that FIG. 6, FIG. 7, and FIG. 8 illustrate a process up to the preprocessing, a process of the host side after the preprocessing, and a process of the DPU 18 side after the preprocessing, respectively.

Furthermore, in those FIGS. 6 to 8, the processor 11 executes a runtime profiler 201 to implement the function as the processing determination unit 102, and executes a worker thread 202 to implement the functions as the host processing notification unit 103 and the first data processing unit 104. Furthermore, the processor 21 of the DPU 18 executes a control thread 203 to implement the functions as the request detection unit 105 and the DPU processing notification unit 107, and executes a worker thread 204 to implement the functions as the second data processing unit 110 and the preprocessing unit 111.

As illustrated in FIG. 6, first, the HPC application 100 issues a request for asynchronous data processing related to I/O data. The control data management unit 101 generates the control data 112 (see reference sign P1 in FIG. 6).

Next, the control thread 203 of the DPU 18 performs polling on the control data 112 by the RDMA Read (see reference sign P2 in FIG. 6). Furthermore, the control thread 203 detects a request in the control data 112, and starts the worker thread 204 of the DPU 18.

The worker thread 204 of the DPU 18 executes preprocessing (see reference sign P3 in FIG. 6).

Furthermore, the control thread 203 of the DPU 18 writes a preprocessing result in the control data 112 by the RDMA Write (see reference sign P4 in FIG. 6). The host executes the runtime profiler 201.

Note that, in a case of data processing that does not need preprocessing, the processing indicated by the reference signs P3 and P4 described above is skipped, and profiling is carried out from the time point of the request.

On the host side, as illustrated in FIG. 7, the runtime profiler 201 determines timing at which the worker thread 202 may be executed (see reference sign P5 in FIG. 7). The execution of the I/O data processing on the host side is treated as speculative execution, and is abandoned here if the timing is not found.

The worker thread 202 writes a host processing mark in the control data 112 (see reference sign P6 in FIG. 7). Here, in a case where a DPU processing mark has already been set in the control data 112, the worker thread 202 abandons the I/O data processing, and suppresses execution of the I/O data request processing by the worker thread 202.

Thereafter, the worker thread 202 executes the I/O data processing (see reference sign P7 in FIG. 7).

On the other hand, on the DPU 18 side, as illustrated in FIG. 8, the DPU 18 (I/O data acquisition unit 109) copies the I/O data by the RDMA Read, and stores it in the I/O data storage unit 108 (see reference sign P5 in FIG. 8).

Note that there is a possibility that the host speculatively executes the processing on the I/O data in the back of this. For example, it is highly likely that the speculative execution may be enabled on the host side for data processing that waits to some extent, such as write back in storage control.

The control thread 203 writes a DPU processing mark in the control data 112 by the RDMA ATOMIC (see reference sign P6 in FIG. 8). However, in a case where a host processing mark has already been set in the control data 112, the execution of the I/O data request processing by the DPU 18 is abandoned, and the execution of the I/O data request processing by the worker thread 204 is suppressed.

Thereafter, the worker thread 204 executes the I/O data processing (see reference sign P7 in FIG. 8).

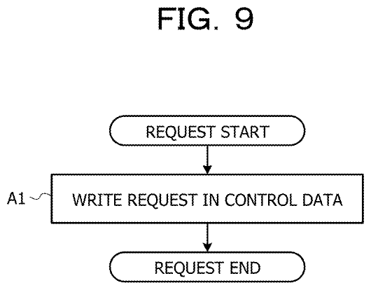

Next, a process at the time of request issuance on the host side in the information processing apparatus 1 as an example of the embodiment will be described with reference to a flowchart (step A1) illustrated in FIG. 9.

In step A1, when the HPC application 100 issues a request related to the I/O data, the control data management unit 101 creates the control data 112, and writes contents of the request (step A1). Thereafter, the process is terminated.

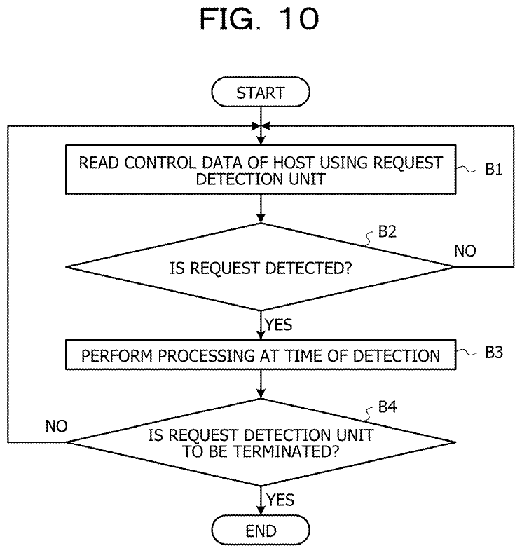

Next, a process of the request detection unit 105 in the information processing apparatus 1 as an example of the embodiment will be described with reference to a flowchart (steps B1 to B4) illustrated in FIG. 10.

In step B1, the request detection unit 105 reads the control data 112 of the host.

In step B2, it is checked whether the request detection unit 105 has detected a request. As a result of the checking, if no request is detected in the control data 112 (see No route of step B2), the process returns to step B1.

On the other hand, if a request is detected in the control data 112 as a result of the checking (see Yes route of step B2), the process proceeds to step B3.

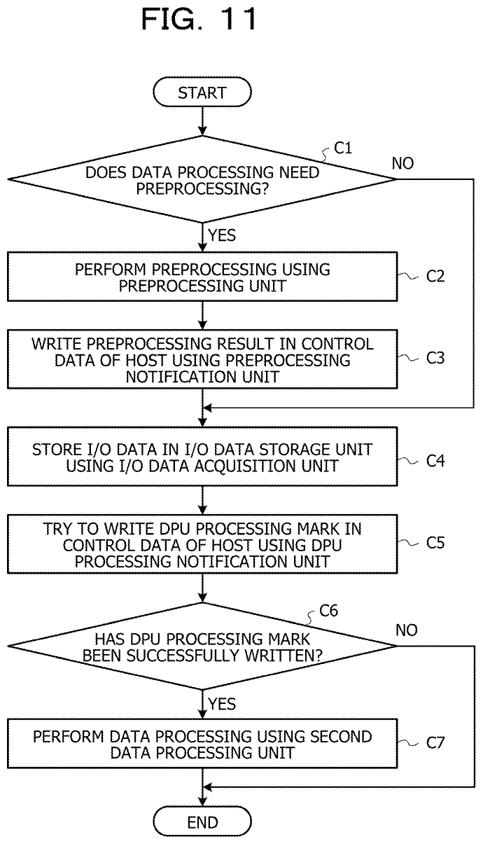

In step B3, processing at the time of request detection is performed in the DPU 18. Note that details of this processing in step B3 will be described later with reference to FIG. 11.

Thereafter, in step B4, the request detection unit 105 checks whether to terminate the execution of the request detection processing. As a result of the checking, if the execution of the request detection processing is not terminated (No route of step B4), the process returns to step B1.

Furthermore, as a result of the checking in step B4, if the processing of the request detection unit 105 is to be terminated (see Yes route of step B4), the process is terminated.

Next, details of step B3 of the flowchart illustrated in FIG. 10, for example, a process in the DPU 18 at the time of request detection, will be described with reference to a flowchart (steps C1 to C7) illustrated in FIG. 11.

In step C1, the request detection unit 105 checks whether it is data processing that needs preprocessing. As a result of the checking, if it is the data processing that needs preprocessing (see Yes route of step C1), the process proceeds to step C2.

In step C2, the preprocessing unit 111 executes the preprocessing.

In step C3, the preprocessing notification unit 106 writes a result of the preprocessing in the control data 112.

In step C4, the I/O data acquisition unit 109 reads the I/O data to store it in the I/O data storage unit 108. Furthermore, as a result of the checking in step C1, if it is not the data processing that needs preprocessing as well (see No route of step C1), the process proceeds to step C4.

In step C5, the DPU processing notification unit 107 tries whether a DPU processing mark may be written in the control data 112 by the RDMA ATOMIC.

In step C6, whether it has been succeeded to write the DPU processing mark in the control data 112 is checked. As a result of the checking, if it has been succeeded to write the DPU processing mark in the control data 112 (see Yes route of step C6), the process proceeds to step C7.

In step C7, the second data processing unit 110 processes the request related to the I/O data. Thereafter, the process is terminated. Furthermore, as a result of the checking in step C6, if it has failed to write the DPU processing mark in the control data 112 (see No route of step C6), the process is terminated.

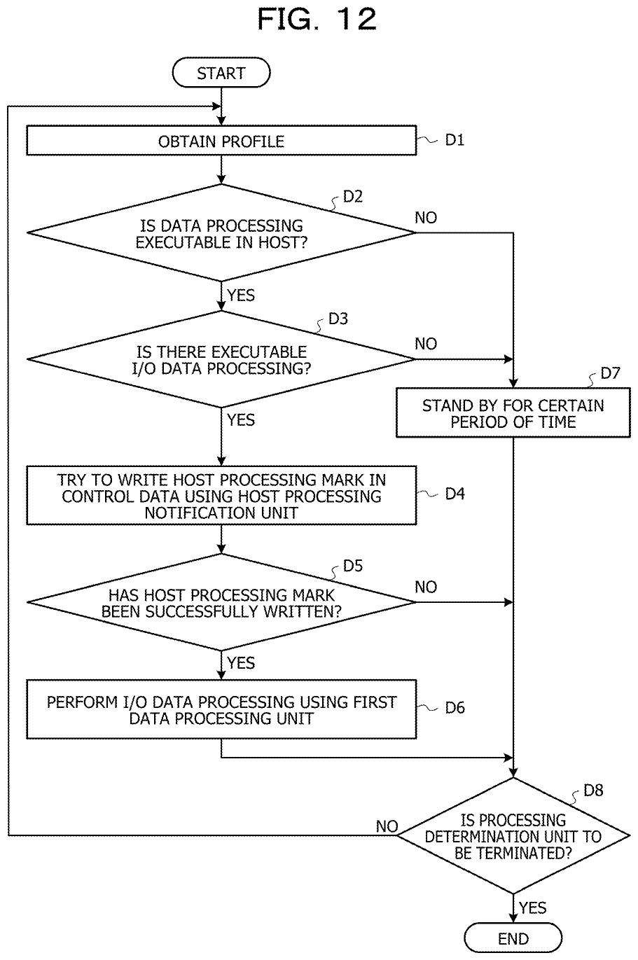

Next, a process of the processing determination unit 102 of the host in the information processing apparatus 1 as an example of the embodiment will be described with reference to a flowchart (steps D1 to D8) illustrated in FIG. 12.

In step D1, the processing determination unit 102 obtains a profile of the processor 11.

In step D2, the processing determination unit 102 determines whether or not the I/O data processing may be performed in the host based on the obtained profile. For example, when the value of the obtained profile is lower than a preset threshold, the processing determination unit 102 determines that the processor 11 (host) is capable of executing the I/O data processing.

As a result of this determination, if the I/O data processing may be executed in the host (see Yes route of step D2), the process proceeds to step D3.

In step D3, the host processing notification unit 103 refers to the control data 112 to check whether there is a request related to the I/O data that may be executed in the host. As a result of the checking, if there is a request related to the I/O data that may be executed (see Yes route of step D3), the process proceeds to step D4.

In step D4, the host processing notification unit 103 attempts to write a host processing mark in the control data 112.

Thereafter, in step D5, the host processing notification unit 103 checks whether it has been succeeded to write the host processing mark in the control data 112. As a result of the checking, if it has been succeeded to write the host processing mark in the control data 112 (see Yes route of step D5), the process proceeds to step D6.

In step D6, the first data processing unit 104 executes the I/O data request processing. Thereafter, the processing determination unit 102 proceeds to step D8.

Furthermore, as a result of the checking in step D5, if it has failed to write the host processing mark in the control data 112 as well (see No route of step D5), the process proceeds to step D8.

Furthermore, as a result of the checking in step D2, if the I/O data processing is not executable in the host (see No route of step D2), the process proceeds to step D7. Furthermore, as a result of the checking in step D3, if there is no executable I/O data request as well (see No route of step D3), the process proceeds to step D7. In step D7, it stands by for a certain period of time. Thereafter, the process proceeds to step D8.

In step D8, it is checked whether to terminate the process of the processing determination unit 102. For example, it may be determined that the end condition of the process of the processing determination unit 102 is satisfied when an operation input of a power shutdown of the present information processing apparatus 1 or the like is made. If the end condition of the process of the processing determination unit 102 is satisfied (see Yes route of step D8), the process is terminated.

If the process of the processing determination unit 102 is not terminated (see No route of step D8), the process returns to step D1.

### (C) Effects

As described above, according to the information processing apparatus 1 as an example of the embodiment, the processing determination unit 102 determines to cause the first data processing unit 104 of the host to execute the request related to the I/O data when the profile value (CPU usage rate, etc.) representing the load state of the processor 11 is lower than the threshold.

As a result, in a state where the load on the processor 11 of the host is low (empty state), the request related to the I/O data may be processed at a high speed using this processor 11. Furthermore, at this time, the request related to the I/O data is processed in the state where the load on the processor 11 of the host is low (empty state), whereby no OS noise is generated.

On the other hand, when the profile value (CPU usage rate, etc.) representing the load state of the processor 11 is equal to or higher than the threshold, the processing determination unit 102 determines not to cause the first data processing unit 104 of the host to execute the request related to the I/O data. In this case, the first data processing unit 104 of the host does not process the request related to the I/O data. Meanwhile, in the DPU 18, the I/O data acquisition unit 109 obtains the I/O data, and the second data processing unit 110 executes the request related to the I/O data.

For example, the host and the DPU 18 cooperate, and when the host (processor 11) is in a high-load state, the I/O data request processing is offloaded to the DPU 18, and the DPU 18 processes the request related to the I/O data. As a result, the processor 11 is not used for the I/O data processing, whereby the request related to the I/O data may be processed without generating OS noise.

By suppressing the generation of the OS noise, it becomes possible to run the HPC application 100 without any concern for performance degradation even in the cloud, which may improve the cost performance.

When the HPC application 100 issues an asynchronous I/O data processing request, the control data management unit 101 creates the control data 112 for processing the I/O data in cooperation between the host and the DPU 18.

In this control data 112, either the host processing mark or the DPU processing mark is exclusively set as the processing entity information, whereby the host and the DPU 18 are enabled to cooperate to process the request related to the I/O data.

Which of the host or the DPU 18 processes the asynchronous I/O data is appropriately switched according to the workload of the host, whereby the HPC application 100 may be run with high performance even in the cloud, and the cost performance may improve.

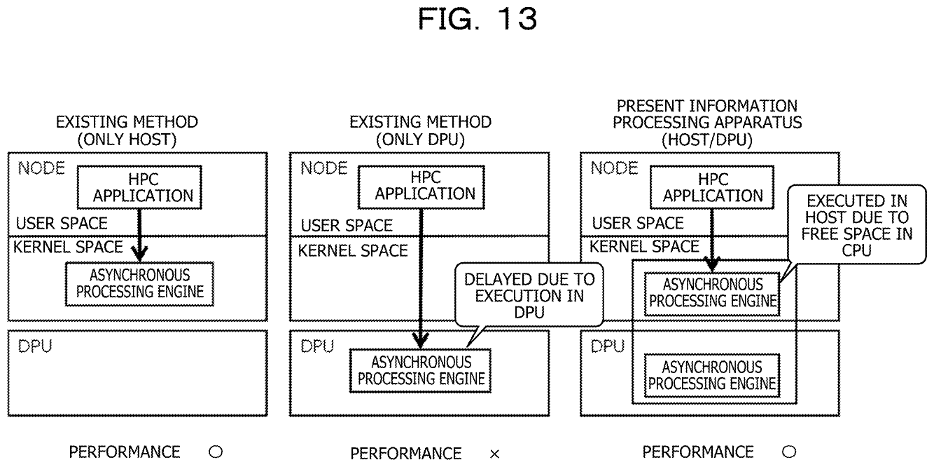

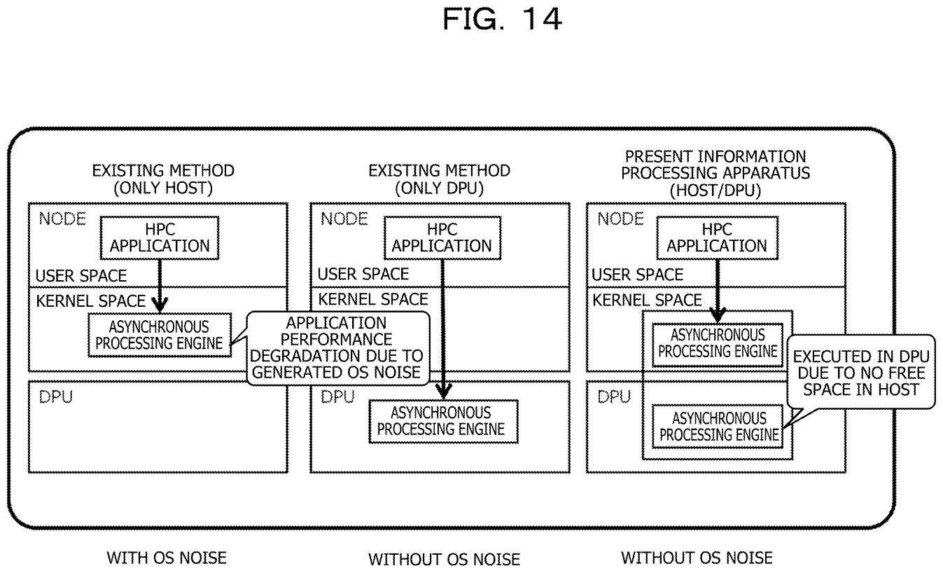

FIGS. 13 and 14 are diagrams illustrating the asynchronous processing of the I/O data by the present information processing apparatus 1 in comparison with an existing method.

FIG. 13 illustrates a state where there is a free space in the host processor 11. As illustrated in this FIG. 13, in the state where there is a free space in the host processor 11, the asynchronous processing of the I/O data may be performed with high performance by being performed in the host according to the present information processing apparatus 1 and the existing method of performing the asynchronous processing of the I/O data only in the host. On the other hand, according to the existing method of performing the asynchronous processing of the I/O data only in the DPU, the asynchronous processing of the I/O data is performed in the DPU whose performance is lower than that of the processor 11, whereby the performance is low.

FIG. 14 illustrates a state where there is no free space in the host processor 11. As illustrated in this FIG. 14, in the state where there is no free space in the host processor 11, the asynchronous processing of the I/O data may be performed without generating OS noise in the DPU according to the present information processing apparatus 1 and the existing method of performing the asynchronous processing of the I/O data only in the DPU. On the other hand, according to the existing method of performing the asynchronous processing of the I/O data only in the host, the asynchronous processing of the I/O data is performed by the host processor in the high-load state, whereby the OS noise is generated.

Therefore, according to the present information processing apparatus 1, the asynchronous processing of the I/O data may be performed with high performance in the state where there is a free space in the host processor 11, and the asynchronous processing of the I/O data may be performed without generating the OS noise in the state where there is no free space in the host processor 11.

### (D) Others

Each configuration and each processing of the present embodiments may be selected or omitted as needed, or may be appropriately combined.

Additionally, the disclosed technique is not limited to the embodiments described above, and various modifications may be made and implemented in a range without departing from the gist of the present embodiments.

For example, while it is indicated that the cloud virtual infrastructure may be Kubernetes in the embodiment described above, it is not limited to this. A method other than Kubernetes, such as docker, may be used as the virtual infrastructure. Furthermore, a virtual machine technique such as VMware may be used as the virtual infrastructure, which may be appropriately modified and implemented.

Furthermore, the present embodiments may be carried out and manufactured by those skilled in the art according to the disclosure described above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a data control process in an information processing apparatus including:
a first processor; and
a second processor that has a processing speed slower than the processing speed of the first processor, the process comprising:
upon reception of a request for asynchronous data processing, causing the first processor to execute processing that determines whether or not to offload processing of the request to the second processor based on a state of the first processor.

2. The non-transitory computer-readable recording medium according to claim 1, the recording medium storing the program for causing the computer to execute the data control process further comprising:
when a value that represents a load state of the first processor is equal to or higher than a threshold, causing the first processor to execute processing that suppresses execution of the processing of the request by the first processor, wherein
the second processor has a function that executes the processing of the request received by the first processor.

3. The non-transitory computer-readable recording medium according to claim 2, the recording medium storing the program for causing the computer to execute the data control process further comprising: when the value that represents the load state of the first processor is lower than the threshold, causing the first processor to execute processing that determines that the first processor executes the processing of the request.

4. The non-transitory computer-readable recording medium according to claim 2, the recording medium storing the program for causing the computer to execute the data control process further comprising:
when the processing of the request is determined to be executed by the first processor, causing the first processor to execute processing that sets, in control information that manages a processing entity of the request, information that indicates that the first processor executes the processing of the request, wherein
the second processor has a function that suppresses the execution of the processing of the request when the information that indicates that the first processor executes the processing of the request is set in the control information.

5. The non-transitory computer-readable recording medium according to claim 1, wherein the second processor is included in a data processing unit (DPU).

6. A data control method in an information processing apparatus including:
a first processor; and
a second processor that has a processing speed slower than the processing speed of the first processor, the method comprising:
upon reception of a request for asynchronous data processing, causing the first processor to execute processing that determines whether or not to offload processing of the request to the second processor based on a state of the first processor.

7. The data control method according to claim 6, further comprising:
when a value that represents a load state of the first processor is equal to or higher than a threshold, causing the first processor to execute processing that suppresses execution of the processing of the request by the first processor, wherein
the second processor has a function that executes the processing of the request received by the first processor.

8. The data control method according to claim 7, further comprising:
when the value that represents the load state of the first processor is lower than the threshold, causing the first processor to execute processing that determines that the first processor executes the processing of the request.

9. The data control method according to claim 7, further comprising:
when the processing of the request is determined to be executed by the first processor, causing the first processor to execute processing that sets, in control information that manages a processing entity of the request, information that indicates that the first processor executes the processing of the request, wherein
the second processor has a function that suppresses the execution of the processing of the request when the information that indicates that the first processor executes the processing of the request is set in the control information.

10. The data control method according to claim 6, wherein the second processor is included in a data processing unit (DPU).

11. A information processing apparatus including:
a first processor; and
a second processor that has a processing speed slower than the processing speed of the first processor,
wherein the first processor, upon reception of a request for asynchronous data processing, executes processing that determines whether or not to offload processing of the request to the second processor based on a state of the first processor.

12. The information processing apparatus according to claim 11, wherein the first processor,
when a value that represents a load state of the first processor is equal to or higher than a threshold, executes processing that suppresses execution of the processing of the request by the first processor, and
the second processor has a function that executes the processing of the request received by the first processor.

13. The information processing apparatus according to claim 12, wherein the first processor, when the value that represents the load state of the first processor is lower than the threshold, executes processing that determines that the first processor executes the processing of the request.

14. The information processing apparatus according to claim 12, wherein the first processor,
when the processing of the request is determined to be executed by the first processor, executes processing that sets, in control information that manages a processing entity of the request, information that indicates that the first processor executes the processing of the request, wherein
the second processor has a function that suppresses the execution of the processing of the request when the information that indicates that the first processor executes the processing of the request is set in the control information.

15. The information processing apparatus according to claim 11, wherein the second processor is included in a data processing unit (DPU).
